(19) United States
(12) Patent Application Publication
(10) Pub. No.: US 2025/0367560 A1
(43) Pub. Date: Dec. 4, 2025

(54) VIRTUAL CHARACTER CONTROL METHOD AND APPARATUS, DEVICE, MEDIUM, AND PROGRAM PRODUCT

(71) Applicant: Tencent Technology (Shenzhen) company Limited, Shenzhen (CN)

(72) Inventor: Huifei BAO, Shenzhen (CN)

(21) Appl. No.: 19/298,118

(22) Filed: Aug. 12, 2025

Related U.S. Application Data
(63) Continuation of application No. PCT/CN2024/088193, filed on Apr. 17, 2024.

(30) Foreign Application Priority Data
Jun. 15, 2023 (CN) 202310713900.X

(51) Int. Cl. A63F 13/58; A63F 13/533

(52) U.S. Cl. CPC A63F 13/58; A63F 13/533

(57) ABSTRACT

This application provides a virtual character control method performed by a computer device. The method includes: displaying a virtual character located in a virtual environment and a button control having a basic appearance style; controlling the virtual character to perform a first activity in response to a first trigger operation on the button control having the basic appearance style; switching, when the virtual environment and/or the virtual character satisfies a preset condition, the button control having the basic appearance style from the basic appearance style to an enhanced appearance style; and controlling the virtual character to perform a second activity in response to a second trigger operation on the button control having the enhanced appearance style. According to the method, occupation of a control on an area on a screen can be reduced, and a time point of function switching can also be prompted.

### CROSS-REFERENCE TO RELATED APPLICATIONS

This application is a continuation application of PCT Patent Application No. PCT/CN2024/088193, entitled “VIRTUAL CHARACTER CONTROL METHOD AND APPARATUS, DEVICE, MEDIUM, AND PROGRAM PRODUCT” filed on Apr. 17, 2024, which claims priority to Chinese Patent Application No. 202310713900.X, entitled “VIRTUAL CHARACTER CONTROL METHOD AND APPARATUS, DEVICE, MEDIUM, AND PROGRAM PRODUCT” filed on Jun. 15, 2023, both of which are incorporated by reference in their entirety.

### FIELD OF THE TECHNOLOGY

This application relates to the technical field of human-computer interaction on a user interface, and in particular, to virtual character control technologies.

### BACKGROUND OF THE DISCLOSURE

In some game applications, a virtual environment interface includes a plurality of controls, and the plurality of controls are configured to control a virtual character to perform activities in a virtual environment.

The plurality of controls include a control configured to trigger an attack skill, and one virtual character may possess a plurality of attack skills. For example, the plurality of attack skills include: a normal attack, a heavy attack, and a derived attack. The normal attack is a basic attack having no additional consumption (for example, consumption of energy, anger, storage, or a magic point) and no cool-down time in a game. The heavy attack is an attack after charging in the game, and outputs a higher damage point and a stronger energy burst than the normal attack. The derived attack is a high-order skill derived based on the normal attack or the heavy attack, and outputs a higher damage point and a stronger energy burst than the heavy attack. The normal attack, the heavy attack, and the derived attack each correspond to one control.

A plurality of controls corresponding to the plurality of skills occupy a large area on the interface.

### SUMMARY

Embodiments of this application provide a virtual character control method and apparatus, a device, a medium, and a program product. The technical solutions are as follows:

According to one aspect of this application, a virtual character control method is performed by a computer device. The method includes:
displaying a virtual character located in a virtual environment and a button control having a basic appearance style;
controlling the virtual character to perform a first activity in response to a first trigger operation on the button control having the basic appearance style;
when the virtual environment and the virtual character satisfies a preset condition, switching the button control having the basic appearance style from the basic appearance style to an enhanced appearance style; and
controlling the virtual character to perform a second activity in response to a second trigger operation on the button control having the enhanced appearance style.

According to another aspect of this application, a computer device is provided. The computer device includes a processor and a memory. The memory has at least one program stored therein. The at least one program is loaded and executed by the processor and causes the computer device to implement the virtual character control method provided in the aspects of this application.

According to another aspect of this application, a non-transitory computer-readable storage medium is provided. The computer-readable storage medium has at least one program stored therein. The at least one program is loaded and executed by a processor of a computer device and causes the computer device to implement the virtual character control method provided in the aspects of this application.

According to another aspect of this application, a chip is provided. The chip includes a programmable logic circuit and/or program instructions. When the chip runs, the chip is configured to implement the virtual character control method provided in the aspects of this application.

The technical solutions provided in the embodiments of this application include at least the following beneficial effects.

According to the virtual character control method provided in this application, one button control may be configured to control a virtual character to perform three activities. When the button control is displayed in a basic appearance style, the virtual character may be controlled to perform a first activity based on a first trigger operation on the button control, or the virtual character may be controlled to perform a second activity based on a second trigger operation on the button control. When the button control is displayed in an enhanced appearance style, the virtual character is controlled to perform a third activity based on the second trigger operation on the button control. Triggering of three functions is implemented by using one button control and two trigger operations. Compared with that each function corresponds to one control, occupation of an area on a screen is reduced. In addition, two trigger operations are performed on one control, which is easy for a user to operate. In this way, the problem that a plurality of operations are mixed up during use because excessive operations are integrated on one control does not occur. In the method, a user is also notified of a function change on a control by using an appearance style change of the button control, so that the user can accurately learn a time point of the function change, thereby better grasping a function trigger occasion.

### BRIEF DESCRIPTION OF THE DRAWINGS

To describe the technical solutions of the embodiments of this application more clearly, the following briefly introduces the accompanying drawings required for describing the embodiments. Apparently, the accompanying drawings in the following description show merely some embodiments of this application, and a person of ordinary skill in the art may still derive other drawings from the accompanying drawings without creative efforts.

FIG. 1 is a schematic structural diagram of a computer system according to an exemplary embodiment of this application.

FIG. 2 is a schematic diagram of an interface for controlling a virtual character according to an exemplary embodiment of this application.

FIG. 3 is a flowchart of a virtual character control method according to an exemplary embodiment of this application.

FIG. 4 is a schematic diagram of an interface for switching an appearance style of a control according to an exemplary embodiment of this application.

FIG. 5 is a schematic diagram of an interface for switching an appearance style of a control according to an exemplary embodiment of this application.

FIG. 6 is a flowchart of a virtual character control method according to an exemplary embodiment of this application.

FIG. 7 is a schematic diagram of an interface for displaying information related to a button control according to an exemplary embodiment of this application.

FIG. 8 is a flowchart of a virtual character control method according to an exemplary embodiment of this application.

FIG. 9 is a schematic diagram of an interface for switching an appearance style of a control according to an exemplary embodiment of this application.

FIG. 10 is a schematic diagram of an interface for switching an appearance style of a control according to an exemplary embodiment of this application.

FIG. 11 is a flowchart of a virtual character control method according to an exemplary embodiment of this application.

FIG. 12 is a block diagram of a virtual character control apparatus according to an exemplary embodiment of this application.

FIG. 13 is a schematic structural diagram of a computer device according to an exemplary embodiment of this application.

### DESCRIPTION OF EMBODIMENTS

To make objectives, technical solutions, and advantages of this application clearer, the following further describes the implementations of this application in detail with reference to the accompanying drawings.

First, terms involved in embodiments of this application are introduced as follows:

A virtual environment is a virtual environment displayed (or provided) when an application runs on a terminal. The virtual environment may be a simulated environment of a real world, or may be a semi-simulated and semi-fictional environment, or may be a completely fictional environment. The virtual environment may be any one of a two-dimensional virtual environment, a 2.5-dimensional virtual environment, and a three-dimensional virtual environment. This is not limited in this application. Description is made by using an example in which the virtual environment is a three-dimensional virtual environment in the following embodiments.

A virtual character is a movable object in a virtual environment. The movable object may be a virtual person, a virtual animal, a cartoon person, or the like, such as a person, an animal, a plant, an oil drum, a wall, or a stone displayed in the three-dimensional virtual environment. In one embodiment, the virtual character is a three-dimensional model created based on an animation skeleton technology. Each virtual character has its own shape and volume in the three-dimensional virtual environment, and occupies a part of space in the three-dimensional virtual environment.

A virtual item is an item used by a virtual character in a virtual environment to perform some activities, for example, a virtual vehicle or a virtual instrument. For example, a virtual explosive is a virtual article that can explode in the virtual environment, and is a virtual instrument used by the virtual character in the virtual environment. When the virtual explosive, including at least one of a grenade, a land mine, a bomb, a fission bomb, and a missile, is detonated (or explodes), a health point of a virtual character within an explosion range is reduced. For another example, a shooting virtual item may be configured for shooting in the virtual environment, and is another virtual instrument used by the virtual character in the virtual environment. When the shooting virtual item (such as a bow and arrow) is configured for shooting, a health point of an enemy virtual character is reduced by shooting the enemy virtual character within a shooting range.

Exemplarily, a virtual item “equipped, carried, or assembled” by the virtual character includes the virtual item that is being used. The virtual character has a virtual backpack, the virtual backpack has backpack grids, and a virtual item that is not used temporarily may be stored in the virtual backpack of the virtual character. The virtual item “equipped, carried, or assembled” by the virtual character may also include the virtual item stored in the virtual backpack.

A control is a user interface (UI) control, which is any visual control or element that can be seen on a user interface of an application. The control is, for example, a picture, an input box, a text box, a button, or a label. Some UI controls may respond to an operation of a user. For example, the user triggers a button control in different appearance styles, to control the virtual character to perform different activities.

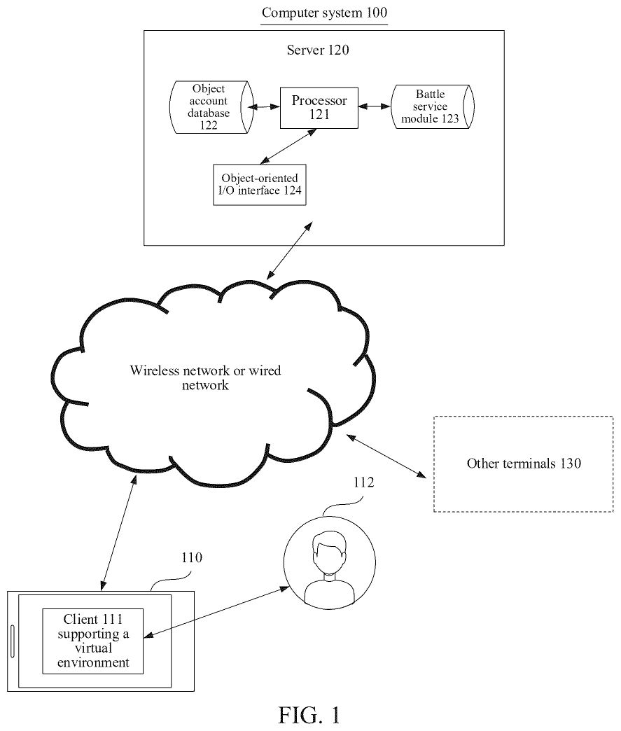

A virtual character control method provided in this application may be applied to a computer system. FIG. 1 is a schematic diagram of a computer system 100 according to an exemplary embodiment of this application. The computer system 100 includes a terminal 110 and a server 120.

A client 111 supporting a virtual environment is installed and run on the terminal 110. The client 111 may be a client of any one of the following applications: a virtual reality (VR) application, an augmented reality (AR) program, a first-person shooting (FPS) game, a third-personal shooting (TPS) game, a multiplayer online battle arena (MOBA) game, a simulation game (SLG), an adventure game, and a role-playing game. When the terminal 110 runs the client 111, a user interface of the client 111 is displayed on a screen of the terminal 110, for example, a virtual environment interface in a game is displayed. The terminal 110 is a terminal used by a user 112. The user 112 controls, by using the terminal 110, a virtual character located in the virtual environment to perform an activity. The activity includes, but is not limited to, at least one of body posture adjustment, crawling, walking, running, riding, jumping, driving, shooting, swinging a sword, throwing a fist, springing, throwing a virtual smoke bomb, and throwing a virtual explosive. Exemplarily, the virtual character is a virtual person, for example, a simulated person or a cartoon person.

The terminal 110 may be generally one of a plurality of terminals. In this embodiment, only the terminal 110 is used as an example for description. Device types of the terminal 110 include at least one of a smart phone, a tablet computer, a notebook computer, a wearable device, an AR intelligent device, a VR intelligent device, an e-book reader, a moving picture experts group audio layer III (MP3) player, a moving picture experts group IV (MP4) player, a laptop computer, and a desktop computer.

FIG. 1 shows only one terminal, but a plurality of other terminals 130 may access the server 120 in different embodiments. In one embodiment, one or more terminals 130 are terminals corresponding to a developer. A developing and editing platform for the client supporting the virtual environment is installed on the terminal 130. The developer may edit and update the client on the terminal 130 and transmit an updated client installation package to the server 120 by using a wired network or a wireless network. The terminal 110 may download the client installation package from the server 120 to update the client.

The terminal 110 and the other terminals 130 are connected to the server 120 by using a wireless network or a wired network.

The server 120 includes at least one of one server, a plurality of servers, a cloud computing platform, and a virtualization center. The server 120 is configured to provide a back-end service for the client 111. In one embodiment, the server 120 takes on primary computing work, and the terminal 110 takes on secondary computing work. Alternatively, the server 120 takes on the secondary computing work, and the terminal 110 takes on the primary computing work. Alternatively, collaborative computing is performed by using a distributed computing architecture between the server 120 and the terminal 110.

In one embodiment, the server 120 includes a processor 121, an object account database 122, a battle service module 123, and an object-oriented input/output interface (I/O interface) 124. The processor 121 is configured to load instructions stored in the server 120, and process data in the object account database 122 and the battle service module 123. The object account database 122 is configured for storing data of object accounts used by the terminal 110 and the other terminals 130, for example, avatars of the object accounts, nicknames of the object accounts, battle effectiveness indexes of the object accounts, and service areas in which the object accounts are located. The battle service module 123 is configured to provide a plurality of battle rooms for objects for a battle, for example, a 1V1 battle, a 3V3 battle, or a 5V5 battle. The object-oriented I/O interface 124 is configured to establish communication and exchange data with the terminal 110 and/or the other terminals 130 by using the wireless network or the wired network.

A person skilled in the art may learn that there may be more or fewer terminals. For example, there may be only one terminal, or there may be dozens or hundreds of terminals or more. The quantity and device types of the terminals are not limited in the embodiments of this application.

The virtual character control method provided in this application may be applied to a VR application, an AR application, an FPS game, a TPS game, a TPS game, a MOBA game, a battle arena game, an SLG, an adventure game, and a role-playing game, or the like.

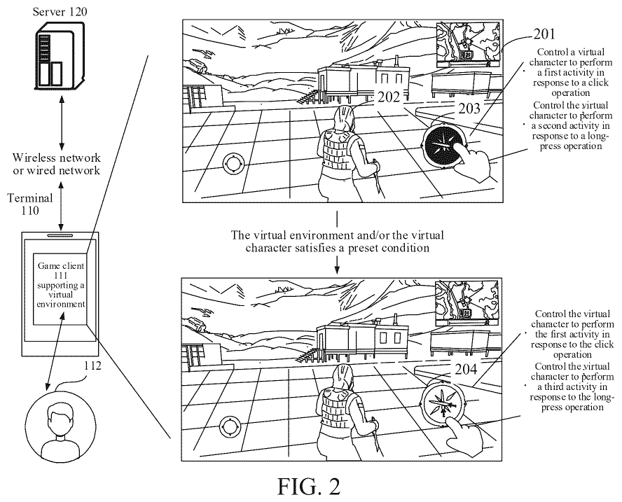

An example in which the virtual character control method is applied to a game is used. As shown in FIG. 2, the terminal 110 runs the client 111 supporting the virtual environment, a virtual character 202 located in a virtual environment 201 is displayed on an interface of the terminal 110, and a plurality of controls are also displayed on the interface of the terminal 110. The user 112 may control, by using the plurality of controls, the virtual character 202 in the virtual environment 201 to perform various activities. The plurality of controls include a button control 203 having a basic appearance style, and a fill color in a circular background area of the button control 203 in the basic appearance style is black. The terminal 110 controls the virtual character 202 to perform a first activity in the virtual environment 201 in response to a click operation on the button control 203. The terminal 110 controls the virtual character 202 to perform a second activity in the virtual environment 201 in response to a long-press operation on the button control 203.

When the virtual environment 201 and/or the virtual character 202 satisfies a preset condition, the terminal 110 switches the basic appearance style of the button control 203 to an enhanced appearance style, and displays a button control 204 having the enhanced appearance style on the interface of the terminal 110, where a fill color in a circular background area of the button control 204 in the enhanced appearance style is white. The terminal 110 may still control the virtual character 202 to perform the first activity in the virtual environment 201 in response to a click operation on the button control 204. The terminal 110 controls the virtual character 202 to perform a third activity in the virtual environment 201 in response to a long-press operation on the button control 204.

In the virtual character control method, three functions are integrated on one control, and execution of a first activity and a second activity, and execution of the first activity and a third activity are respectively triggered in different triggering manners on the control. The control under different functions is presented by using different appearance styles, so that execution of the second activity and execution of the third activity are respectively triggered by using the same trigger operation on the control in different appearance styles. Compared with that each function corresponds to one control, the three functions are implemented by using one control, which can reduce a proportion of occupation on a screen of the terminal. In addition, each switching of the function that can be triggered is presented in different appearance styles, so that the user can quickly and clearly perceive a change of the function that can be triggered on the control.

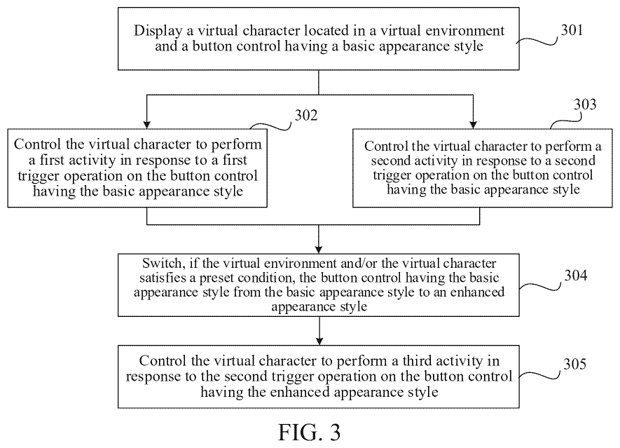

FIG. 3 is a flowchart of a virtual character control method according to an exemplary embodiment of this application. The method may be applied to the terminal of the computer system as shown in FIG. 1. The method includes the following operations.

Operation 301: Display a virtual character located in a virtual environment and a button control having a basic appearance style.

An application is run on the terminal. The application supports the virtual environment, and the virtual character is located in the virtual environment. A virtual environment interface is displayed on the terminal, where the virtual environment interface includes a virtual environment picture, and the virtual environment picture is a picture obtained by observing the virtual environment from a perspective.

The perspective may be an observation angle at which observation is performed in the virtual environment from a first-person perspective or a third-person perspective of the virtual character. Exemplarily, in the embodiments of this application, the perspective is an angle for observing the virtual character by using a camera model in the virtual environment. The camera model performs automatic following on the virtual character in the virtual environment. To be specific, when a position of the virtual character in the virtual environment changes, a position of the camera model changes at the same time with the position of the virtual character in the virtual environment, and the camera model is always located in a preset distance range of the virtual character in the virtual environment. In one embodiment, in an automatic following process, a relative position between the camera model and the virtual character does not change.

The camera model may be a three-dimensional model located around the virtual character in the virtual environment. When the first-person perspective is used, the camera model is located near the head of the virtual character or at the position of the head of the virtual character. When the third-person perspective is used, the camera model may be located behind the virtual character and bound to the virtual character, or may be located at any position from the virtual character by a preset distance. The virtual character located in the virtual environment may be observed from different angles by using the camera model. For example, when the third-person perspective is a first-person over-shoulder perspective, the camera model is located behind the virtual character (for example, the head or the shoulders of a virtual person). In addition to the first-person perspective and the third-person perspective, the perspective further includes another perspective, such as a top perspective. When the top perspective is used, the camera model may be located above the head of the virtual character, and the top perspective is a perspective in which the virtual environment is observed from a perspective of looking up in air. The camera model is not actually displayed in the virtual environment, that is, the camera model is not displayed in the virtual environment displayed on the virtual environment interface. In other words, the camera model is not displayed in the virtual environment picture.

Exemplarily, the virtual environment displayed on the virtual environment picture includes at least one of the following elements: a mountain, a level, a river, a lake, a sea, a desert, sky, a cloud, a sun, a moon, a star, a plant, an animal, a building, and a vehicle.

The virtual environment interface is displayed on the terminal, where the virtual environment interface further includes the button control having the basic appearance style.

In a possible implementation, the button control having the basic appearance style may be a trigger control of a skill possessed by the virtual character. Exemplarily, a skill corresponding to the button control may be a skill possessed by the virtual character, or a skill obtained by the virtual character after the virtual character equips with a virtual item.

If the button control is the control corresponding to the skill possessed by the virtual character, the terminal displays the virtual character located in the virtual environment and the button control having the basic appearance style. For example, the virtual character possesses a skill for performing a striking activity by using a fist, and when a button control is configured to trigger the skill, the terminal displays the virtual character located in the virtual environment and also displays the button control. For another example, the virtual character possesses a skill for performing an attack activity by using a sword, and when a button control is configured to trigger the skill, the terminal displays the virtual character located in the virtual environment and also displays the button control. For another example, the virtual character possesses a skill of a picking-up or picking activity, and when a button control is configured to trigger the skill, the terminal displays the virtual character located in the virtual environment and also displays the button control.

If the button control is the control corresponding to the skill obtained by the virtual character after the virtual character equips with the virtual item, the terminal displays the virtual character located in the virtual environment, controls, in response to an equipping operation of the virtual item, the virtual character to equip with the virtual item, and displays the button control corresponding to the skill associated with the virtual item. For example, after the terminal displays the virtual character located in the virtual environment, the terminal controls, in response to an equipping operation of a virtual shooting tool, the virtual character to equip with the virtual shooting tool, and displays a button control associated with the virtual shooting tool. The button control is configured to control the virtual character to shoot by using the virtual shooting tool. For another example, after the terminal displays the virtual character located in the virtual environment, the terminal controls, in response to an equipping operation of a virtual throwing object, the virtual character to equip with the virtual throwing object, and displays a button control associated with the virtual throwing object. The button control is configured to control throwing of the virtual throwing object. For another example, after the terminal displays the virtual character located in the virtual environment, the terminal controls, in response to an equipping operation of a virtual building tool, the virtual character to equip with the virtual building tool, and displays a button control associated with the virtual building tool. The button control is configured to control the virtual character to build a virtual building by using the virtual building tool.

In a possible implementation, a method of obtaining the virtual item includes, but is not limited to, picking up, purchasing, sharing with another virtual character, and obtaining a reward item after completing a task.

In this embodiment of this application, an appearance style of the button control is formed by at least one of the following elements:
a shape of the button control, for example, the button control may be a circle, a square, or a rhombus;
a fill color of the button control, for example, the button control may be red, yellow, or blue;
transparency of the button control, for example, the transparency of the button control may be 0, or 50%, or 100%;
a pattern on the button control, for example, a pattern associated with a function triggered by the button control may be displayed on the button control, for example, a pattern of an arrow may be displayed on a button control for triggering arrow shooting; and
brightness of the button control, for example, the brightness of the button control may be the same as brightness of another area on the screen, or higher than the brightness of the another area on the screen.

In a possible implementation, an appearance style of the button control when the button control is initially displayed may be the basic appearance style. The basic appearance style may be an appearance style of a button control that controls the virtual character to perform a basic activity. The basic activity may be, for example, a first activity and a second activity. The button control is associated with at least two trigger operations, and the at least two trigger operations are configured for triggering different skills. The at least two skills correspond to different activities. Therefore, the at least two trigger operations are configured for triggering different skills, which may alternatively be described as that the at least two trigger operations are configured for controlling the virtual character to perform different activities.

The at least two trigger operations may include a first trigger operation and a second trigger operation. When the button control is displayed in the basic appearance style, the first trigger operation is configured for controlling the virtual character to perform the first activity, and the second trigger operation is configured for controlling the virtual character to perform the second activity.

The first activity and the second activity are different activities. In a possible implementation, the first activity and the second activity may be different in at least one of the following.

Activities performed by the virtual character are different, for example, the first activity and the second activity are activities in which different combos are used to attack.

Impact degrees caused by the activities performed by the virtual character are different, for example, damage points/heal points caused by the first activity and the second activity are different.

Coverage scopes affected by the activities performed by the virtual character are different, for example, attack scopes/heal scopes corresponding to the first activity and the second activity are different.

The trigger operation includes, but is not limited to, at least one of the following: a single-click operation, a double-click operation, a long-press operation, a press operation, a slide operation, and a drag operation. The first trigger operation and the second trigger operation are different trigger operations. For example, the first trigger operation is a single-click operation, and the second trigger operation is a long-press operation. For another example, the first trigger operation is a single-click operation, and the second trigger operation is a press operation. For another example, the first trigger operation is a single-click operation, and the second trigger operation is a drag operation.

In one embodiment, the button control is located at any position on the virtual environment interface. Exemplarily, the button control may be located in an edge area of the virtual environment interface. For example, the button control is located in a right edge area of the virtual environment interface. Alternatively, the position layout of the button control on the virtual environment interface may be defined by a user. For example, the button control may be dragged to a target position to change the position layout of the button control.

Operation 302: Control the virtual character to perform the first activity in response to the first trigger operation on the button control having the basic appearance style.

When the button control has the basic appearance style, the terminal controls the virtual character to perform the first activity in response to the first trigger operation on the button control having the basic appearance style.

Operation 303: Control the virtual character to perform the second activity in response to the second trigger operation on the button control having the basic appearance style.

When the button control has the basic appearance style, the terminal controls the virtual character to perform the second activity in response to the second trigger operation on the button control having the basic appearance style.

Operation 304: Switch, if the virtual environment and/or the virtual character satisfies a preset condition, the button control having the basic appearance style from the basic appearance style to an enhanced appearance style.

The preset condition may be configured for determining whether the virtual environment and/or the virtual character supports (supports or does not support) the virtual character to perform a third activity. If the virtual environment and/or the virtual character supports the virtual character to perform the third activity, the button control having the basic appearance style may be switched from the basic appearance style to the enhanced appearance style.

It may also be described that the preset condition is a use condition of a skill corresponding to the third activity. If the virtual environment and/or the virtual character satisfies the preset condition, the skill corresponding to the third activity may be used, and through use of the skill, the virtual character is controlled to perform the third activity.

The enhanced appearance style may be an appearance style of a button control that controls the virtual character to perform a strong activity. The strong activity has a higher damage point and stronger burst energy than the basic activity. For example, the strong activity may be the third activity. The enhanced appearance style is different from the basic appearance style. In a possible implementation, at least one of the following elements is different between the enhanced appearance style and the basic appearance style: the shape of the button control; the fill color of the button control; the transparency of the button control; the pattern on the button control; and the brightness of the button control.

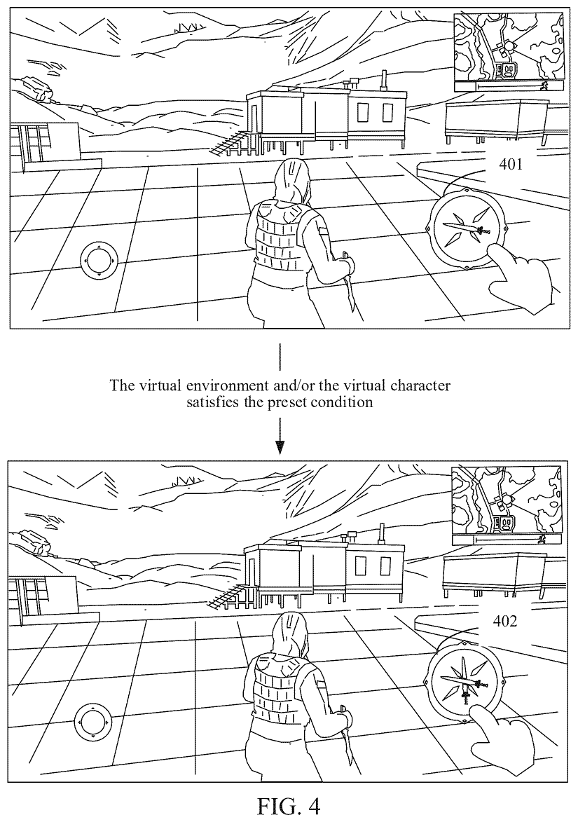

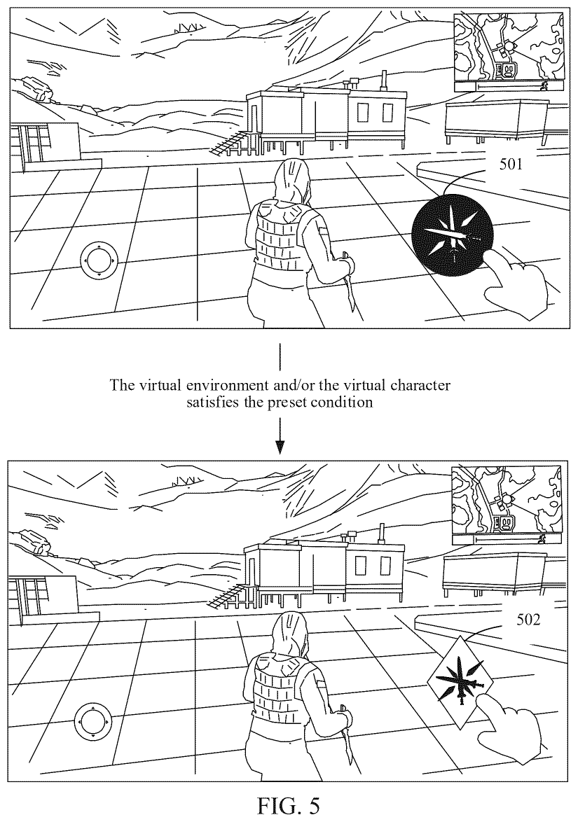

Correspondingly, the switching the button control having the basic appearance style from the basic appearance style to an enhanced appearance style includes at least one of the following operations:
switching a first fill color of the button control having the basic appearance style to a second fill color, for example, as shown in FIG. 2, a fill color of a circular background area of a button control 203 in the basic appearance style is black, and a fill color of a circular background area of a button control 204 in the enhanced appearance style is white;
switching a first pattern displayed on the button control having the basic appearance style to a second pattern, for example, as shown in FIG. 4, a sword is displayed on a button control 401 in the basic appearance style, and two swords placed in a cross manner are displayed on a button control 402 in the enhanced appearance style;
switching first brightness displayed on the button control having the basic appearance style to second brightness, the second brightness being greater than the first brightness, in other words, switching brightness display of the button control to highlight display;
switching first transparency of the button control having the basic appearance style to second transparency; and
switching the shape of the button control having the basic appearance style from a first shape to a second shape, for example, as shown in FIG. 5, a shape of a button control 501 in the basic appearance style is a circle, and a shape of a button control 502 in the enhanced appearance style is a rhombus.

In some embodiments, at least two preset conditions are provided, and the at least two preset conditions are associated with different enhanced appearance styles. Exemplarily, the at least two preset conditions include a first preset condition and a second preset condition. If the virtual environment and/or the virtual character satisfies the first preset condition in the at least two preset conditions, the button control having the basic appearance style is switched from the basic appearance style to a first enhanced appearance style associated with the first preset condition. If the virtual environment and/or the virtual character satisfies the second preset condition in the at least two preset conditions, the button control having the basic appearance style is switched from the basic appearance style to a second enhanced appearance style associated with the second preset condition.

The first enhanced appearance style and the second enhanced appearance style may be the same different. When the first enhanced appearance style and the second enhanced appearance style are different, at least one of the following elements may be different between the first enhanced appearance style and the second enhanced appearance style: the shape of the button control; the fill color of the button control; the transparency of the button control; the pattern on the button control; and the brightness of the button control.

In a possible implementation, in the at least two preset conditions, at least one preset condition is correspondingly associated with at least two skills, and each skill is associated with a respective enhanced appearance style. Exemplarily, the at least one preset condition includes the first preset condition, and the first preset condition is associated with at least two skills. If the virtual environment and/or the virtual character satisfies the first preset condition, a selection control corresponding to the at least two skills is displayed around the button control having the basic appearance style; and the displaying of the selection control is canceled in response to a selection operation for a first skill in the at least two skills on the selection control, and the button control having the basic appearance style is switched from the basic appearance style to a first enhanced appearance style associated with the first skill. If the at least two skills further include a second skill, the displaying of the selection control may alternatively be canceled in response to a selection operation for the second skill on the selection control, and the button control having the basic appearance style is switched from the basic appearance style to an appearance style associated with the second skill.

Alternatively, after the selection control corresponding to the at least two skills is displayed around the button control having the basic appearance style, if a selection operation is not triggered on the selection control and display duration of the selection control reaches fourth duration, the displaying of the selection control is canceled, and the button control having the basic appearance style is switched by default from the basic appearance style to the first enhanced appearance style associated with the first skill in the at least two skills, or the button control having the basic appearance style is randomly switched from the basic appearance style to the first enhanced appearance style associated with the first skill in the at least two skills.

In a possible implementation, in the at least two preset conditions, at least one preset condition is correspondingly associated with at least two skills, and each skill is associated with a respective enhanced appearance style. Exemplarily, the at least one preset condition includes the first preset condition, and the first preset condition is associated with at least two skills. If the virtual environment and/or the virtual character satisfies the first preset condition, the button control having the basic appearance style is randomly switched from the basic appearance style to a first enhanced appearance style associated with a first skill in the at least two skills.

In some other embodiments, one preset condition is provided. The preset condition is correspondingly associated with at least two skills, and each skill is associated with a respective enhanced appearance style. If the virtual environment and/or the virtual character satisfies the preset condition, a selection control corresponding to the at least two skills is displayed around the button control having the basic appearance style; and the displaying of the selection control is canceled in response to a selection operation for a first skill in the at least two skills on the selection control, and the button control having the basic appearance style is switched from the basic appearance style to a first enhanced appearance style associated with the first skill. If the at least two skills further include a second skill, the displaying of the selection control is canceled in response to a selection operation for the second skill in the at least two skills on the selection control, and the button control having the basic appearance style is switched from the basic appearance style to an appearance style associated with the second skill.

Alternatively, if a selection operation is not triggered on the selection control and display duration of the selection control reaches fourth duration, the displaying of the selection control is canceled, and the button control having the basic appearance style is switched by default from the basic appearance style to the first enhanced appearance style associated with the first skill, or the button control having the basic appearance style is randomly switched from the basic appearance style to the first enhanced appearance style associated with the first skill in the at least two skills.

Exemplarily, one or at least two selection controls may be provided. When one selection control is provided, the selection operation may refer to sliding in different directions on the selection control, thereby representing selecting different skills. For example, sliding leftwards on the selection control is to select the first skill; and sliding rightwards on the selection control is to select the second skill. For another example, the selection control is a list control, a plurality of selection controls corresponding to a plurality of skills are displayed on the list control, and a skill is selected by clicking on the selection control. For another example, when the selection control is a plurality of independent controls, each skill corresponds to one selection control, and the skill is selected by clicking the selection control.

In some other embodiments, one preset condition is provided. The preset condition is correspondingly associated with at least two skills, and each skill is associated with a respective enhanced appearance style. If the virtual environment and/or the virtual character satisfies the preset condition, the button control having the basic appearance style is randomly switched from the basic appearance style to a first enhanced appearance style associated with a first skill in the at least two skills.

Exemplarily, the preset condition is a condition that the virtual environment needs to satisfy. Alternatively, the preset condition is a condition that the virtual character needs to satisfy. Alternatively, the preset condition is a condition satisfied by the virtual character and the virtual environment. In a possible implementation, the preset condition includes, but is not limited to, at least one of the following:
The virtual character uses a specified virtual item. For example, the virtual character is controlled to obtain the skill corresponding to the third activity by using the specified virtual item.
A quantity of times that the virtual character performs the first activity or the second activity within first duration exceeds a quantity-of-times threshold. For example, the first activity is a combo, and the virtual character is controlled to continuously stroke the combo twice within the first duration, to obtain the skill corresponding to the third activity.
A damage point outputted by the virtual character when performing the first activity and/or the second activity within second duration is greater than a damage threshold.
Cool-down duration (energy accumulation duration) of the skill corresponding to the third activity reaches third duration. For example, at an initial stage or after the skill is released once, the skill corresponding to the third activity is switched from a releasable state to an unreleasable state, and after energy accumulation is achieved during the cool-down duration, the skill corresponding to the third activity is switched again from the unreleasable state to the releasable state.
The virtual character defeats another object in the virtual environment. For example, the virtual character is controlled to defeat an enemy virtual character in the virtual environment, or a non-player character (NPC), or an environment object in the virtual environment, for example, a specified object such as a gem or a tree in the virtual environment.
A health point of the virtual character is greater than a health threshold.
The virtual environment supports the third activity to be performed. For example, there is an executable area for the third activity in the virtual environment, and the virtual character may perform the third activity in the executable area. For another example, weather of the virtual environment affects execution of the third activity, and when the weather of the virtual environment supports the third activity, the third activity may be performed. For another example, a terrain in the virtual environment affects execution of the third activity, and when a topography of a particular position in the virtual environment supports the third activity, the certain position supports execution of the third activity.

The preset condition is preset according to an application requirement.

In a possible implementation, the basic appearance style may be switched to the first enhanced appearance style in a direct transition manner or a gradient change manner. For example, during energy accumulation, the basic appearance style gradually changes to the first enhanced appearance style.

Operation 305: Control the virtual character to perform the third activity in response to the second trigger operation on the button control having the enhanced appearance style.

When the button control has the enhanced appearance style, the terminal controls the virtual character to perform the third activity in response to the second trigger operation on the button control having the enhanced appearance style.

Exemplarily, by using an example in which the method provided in this embodiment is applied to a game, the first activity is a normal attack, the second activity is a heavy attack, and the third activity is a derived attack. The terminal displays the virtual character in the virtual environment and the button control having the basic appearance style; and controls the virtual character to perform the normal attack in response to a click operation on the button control having the basic appearance style; or controls the virtual character to perform the heavy attack in response to a long-press operation on the button control having the basic appearance style. After the energy accumulation duration reaches the fourth duration, the basic appearance style of the button control having the basic appearance style is switched to the first enhanced appearance style. In this case, the virtual character is controlled to perform the normal attack in response to the click operation on the button control having the first enhanced appearance style, or the virtual character is controlled to perform the derived attack in response to the long-press operation on the button control.

In some other embodiments, after the virtual character is controlled to perform the third activity, the button control having the enhanced appearance style is switched from the enhanced appearance style to the basic appearance style. After the third activity is performed, the third activity can be performed again only after the virtual character and/or the virtual environment satisfies the preset condition again. For example, after the skill corresponding to the third activity is released, energy needs to be re-accumulated, and the third activity can be performed again only after energy accumulation is completed.

In conclusion, according to the virtual character control method provided in this application, one button control may be configured to control a virtual character to perform three activities. When the button control is displayed in a basic appearance style, the virtual character may be controlled to perform a first activity based on a first trigger operation on the button control, or the virtual character may be controlled to perform a second activity based on a second trigger operation on the button control. When the button control is displayed in an enhanced appearance style, the virtual character is controlled to perform a third activity based on the second trigger operation on the button control. Triggering of three functions is implemented by using one button control and two trigger operations. Compared with that each function corresponds to one control, occupation of an area on a screen is reduced. In addition, two trigger operations are performed on one control, which is easy for a user to operate. In this way, the problem that a plurality of operations are mixed up during use because excessive operations are integrated on one control does not occur. In the method, a user is also notified of a function change on a control by using an appearance style change of the button control, so that the user can accurately learn a time point of the function change, thereby better grasping a function trigger occasion.

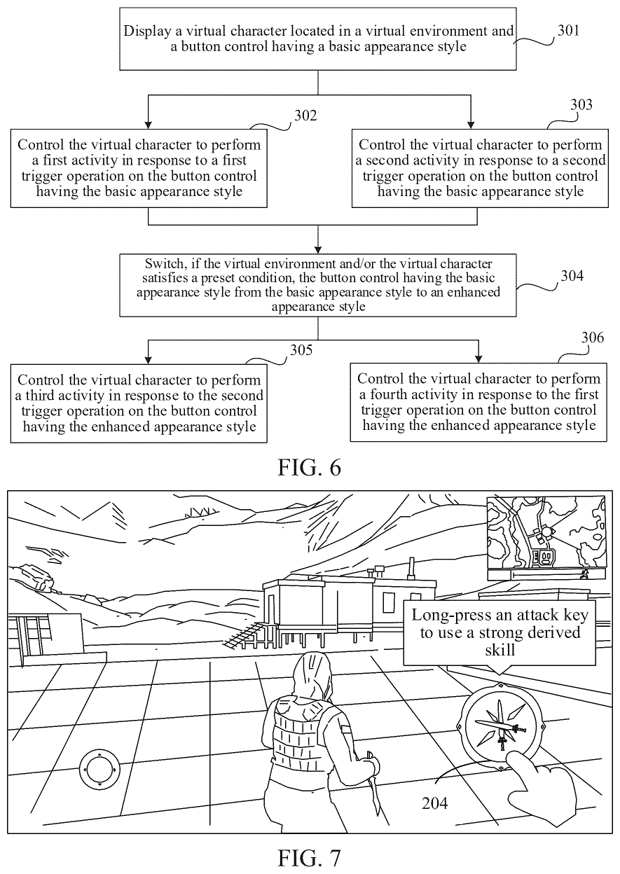

In some other embodiments, as shown in FIG. 6, the embodiment shown in FIG. 3 may also include the following operations.

Operation 306: Control the virtual character to perform a fourth activity in response to the first trigger operation on the button control having the enhanced appearance style.

When the button control has the enhanced appearance style, the terminal controls the virtual character to perform the fourth activity in response to the first trigger operation on the button control having the enhanced appearance style.

The fourth activity may be the same as the first activity, and different from the second activity and the third activity. Alternatively, the fourth activity may be different from each of the first activity, the second activity, and the third activity.

In conclusion, according to the virtual character control method provided in this embodiment, one control may be configured to control the virtual character to perform three or four activities, thereby improving utilization of the control.

In some other embodiments, after the button control having the basic appearance style is switched from the basic appearance style to an enhanced appearance style, prompt content may be further displayed around the button control having the enhanced appearance style, where the prompt content is configured for describing the skill corresponding to the third activity. For example, if the virtual environment and/or the virtual character satisfies the preset condition for the first time, the button control is switched from the basic appearance style to the enhanced appearance style for the first time, and the prompt content is displayed around the button control having the enhanced appearance style. For another example, when the virtual environment and/or the virtual character satisfies the preset condition, the button control is switched from the basic appearance style to the enhanced appearance style, it is determined that the third activity occurs for the first time, and the prompt content is displayed around the button control having the enhanced appearance style.

Exemplarily, the terminal may alternatively display the prompt content in the edge area of the virtual environment interface.

Exemplarily, as shown in FIG. 7, if the enhanced appearance style is the first enhanced appearance style, prompt content “Long-press an attack key to use a strong derived skill” may be displayed above the button control 204 having the first enhanced appearance style.

In conclusion, according to a skill trigger guidance method provided in this embodiment, a skill explanation corresponding to a third activity is provided for a user, so that the user can learn a skill corresponding to the third activity in time, to more properly plan a trigger occasion of the third activity.

In some other embodiments, the user may further reserve the skill corresponding to the third activity based on a third trigger operation on the button control having the enhanced appearance style, to perform the skill at an appropriate moment.

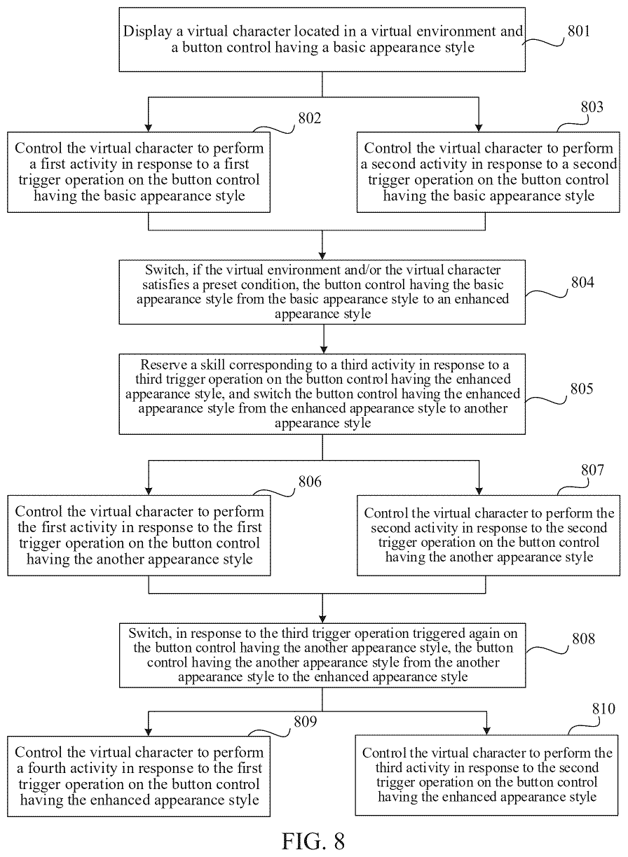

Exemplarily, FIG. 8 is a flowchart of a virtual character control method according to an exemplary embodiment of this application. The method may be applied to the terminal of the computer system as shown in FIG. 1. The method includes the following operations.

Operation 801: Display a virtual character located in a virtual environment and a button control having a basic appearance style.

Operation 802: Control the virtual character to perform a first activity in response to a first trigger operation on the button control having the basic appearance style.

Operation 803: Control the virtual character to perform a second activity in response to a second trigger operation on the button control having the basic appearance style.

Operation 804: Switch, if the virtual environment and/or the virtual character satisfies a preset condition, the button control having the basic appearance style from the basic appearance style to an enhanced appearance style.

For operation 801 to operation 804, reference may be made to detailed descriptions of operation 301 to operation 304. Details are not described herein again.

Operation 805: Reserve a skill corresponding to a third activity in response to a third trigger operation on the button control having the enhanced appearance style, and switch the button control having the enhanced appearance style from the enhanced appearance style to another appearance style.

The another appearance style is different from the enhanced appearance style. In one embodiment, at least one of the following elements is different between the another appearance style and the enhanced appearance style: a shape of the button control; a fill color of the button control; transparency of the button control; a pattern on the button control; and brightness of the button control.

Correspondingly, the switching the button control from the enhanced appearance style to another appearance style includes at least one of the following operations:
switching a second fill color of the button control having the enhanced appearance style to a third fill color;
switching a second pattern displayed on the button control having the enhanced appearance style to a third pattern;
switching second brightness displayed on the button control having the enhanced appearance style to third brightness, the second brightness being greater than the third brightness;
switching second transparency of the button control having the enhanced appearance style to third transparency; and
switching the shape of the button control having the enhanced appearance style from a second shape to a third shape.

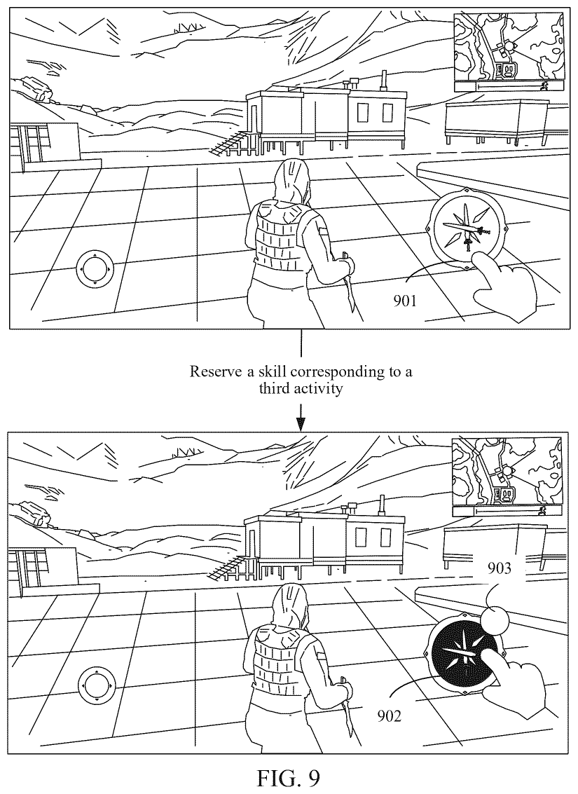

The another appearance style may be the same as the basic appearance style. When the button control is switched from the enhanced appearance style to the basic appearance style, a reservation identifier of the skill corresponding to the third activity is still displayed in the edge area of the button control. Exemplarily, as shown in FIG. 9, a button control 901 in the enhanced appearance style is switched back to a button control 902 in the basic appearance style, and a reservation identifier 903 is displayed at an upper right corner of the button control 902. A style of the reservation identifier in the embodiments of this application is not limited, and may be a circle, an ellipse, a square, a rhombus, or the like.

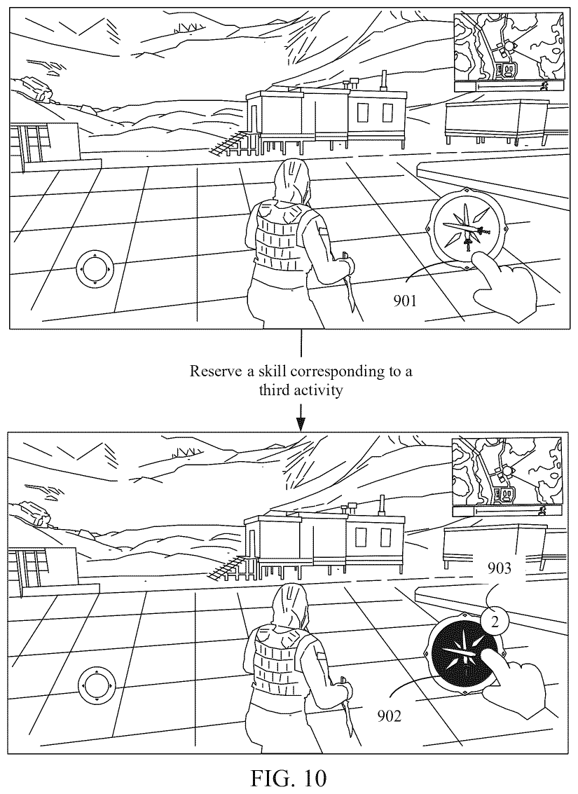

If a quantity of use times of the skill corresponding to the third activity can be accumulated, the quantity of use times may be recorded by using the reservation identifier. For example, as shown in FIG. 10, the quantity of use times is displayed on the reservation identifier 903.

Operation 806: Control the virtual character to perform the first activity in response to the first trigger operation on the button control having the another appearance style.

When the button control has the another appearance style, the terminal controls the virtual character to perform the first activity in response to the first trigger operation on the button control.

Operation 807: Control the virtual character to perform the second activity in response to the second trigger operation on the button control having the another appearance style.

When the button control has the another appearance style, the terminal controls the virtual character to perform the second activity in response to the second trigger operation on the button control having the another appearance style.

Operation 808: Switch, in response to the third trigger operation triggered again on the button control having the another appearance style, the button control having the another appearance style from the another appearance style to the enhanced appearance style.

The third trigger operation triggered again may alternatively be replaced with another trigger operation different from the third trigger operation. For example, the third trigger operation is a slide-up operation on the button control, and the another trigger operation may be a slide-down operation on the button control. For another example, the third trigger operation is a slide-left operation on the button control, and the another trigger operation is a slide-right operation on the button control.

The third trigger operation is different from both the first trigger operation and the second trigger operation. The another trigger operation is different from each of the first trigger operation, the second trigger operation, and the third trigger operation.

Operation 809: Control the virtual character to perform a fourth activity in response to the first trigger operation on the button control having the enhanced appearance style.

When the button control has the enhanced appearance style, the terminal controls the virtual character to perform the fourth activity in response to the first trigger operation on the button control having the enhanced appearance style.

In a possible implementation, the fourth activity may be the same as the first activity, and different from the second activity and the third activity. Alternatively, the fourth activity may be different from each of the first activity, the second activity, and the third activity.

Operation 810: Control the virtual character to perform the third activity in response to the second trigger operation on the button control having the enhanced appearance style.

When the button control has the enhanced appearance style, the terminal controls the virtual character to perform the third activity in response to the second trigger operation on the button control having the enhanced appearance style.

In conclusion, according to a skill reservation method provided in this embodiment, a skill corresponding to a third activity can be reserved, so that a more appropriate occasion can be selected to control a virtual character to perform the third activity, and the third activity can be fully and effectively used. For example, during a game, an ultimate is reserved, and the ultimate is released at an appropriate occasion, thereby obtaining a game victory.

In some other embodiments, if a user does not intend to control the virtual character to perform the third activity, the user may cancel the skill corresponding to the third activity based on a fourth trigger operation on the button control. Exemplarily, after the basic appearance style of the button control is switched to the enhanced appearance style, the skill corresponding to the third activity is canceled in response to the fourth trigger operation on the button control, and the button control is switched from the enhanced appearance style to the basic appearance style.

In conclusion, according to a skill canceling method provided in this embodiment, a user may determine, according to an actual requirement, whether a virtual character needs to be controlled to perform a third activity, and when the virtual character does not need to be controlled to perform the third activity, the user may autonomously cancel a skill corresponding to the third activity, and continue to control the virtual character to perform a first activity and/or a second activity based on a button control having a basic appearance style.

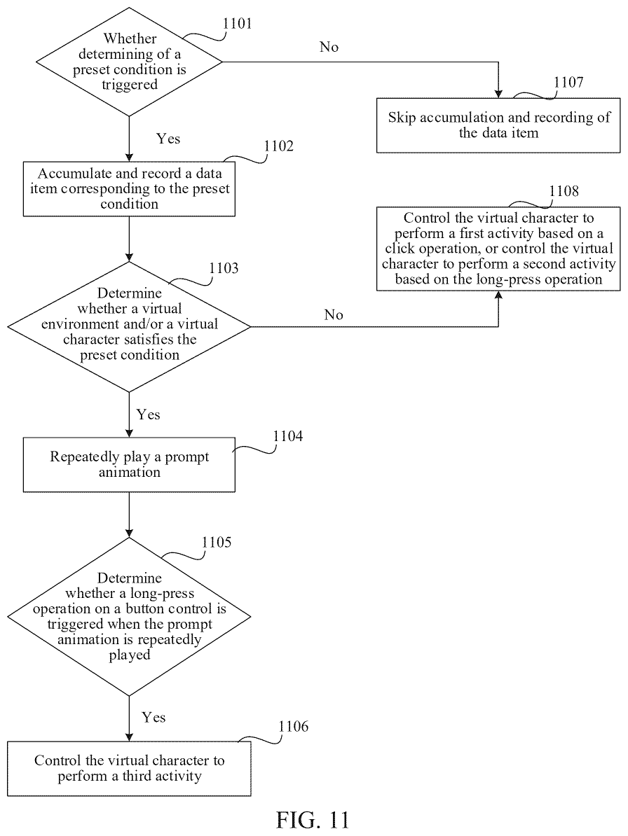

FIG. 11 is a flowchart of a virtual character control method according to an exemplary embodiment of this application. The method may be applied to the terminal of the computer system as shown in FIG. 1, to describe control logic of a virtual character in the embodiments of this application. The method includes the following operations.

Operation 1101: Determine whether determining of a preset condition is triggered.

When the virtual character and/or a virtual environment changes, the terminal obtains a data item causing the change, and determines whether the data item triggers the determining of the preset condition. In other words, a trigger moment is required for determining the preset condition, and when the terminal detects the trigger moment, operation 1102 is performed; otherwise, operation 1107 is performed. For example, the preset condition includes a plurality of conditions, and when the virtual character and/or the virtual environment satisfies one of the plurality of conditions, the determining of the preset condition is triggered.

When the determining of the preset condition is not triggered, operation 1107 is performed.

Operation 1102: Accumulate and record the data item corresponding to the preset condition.

The terminal accumulates and records the data item corresponding to the preset condition. In other words, the data item corresponding to the preset condition is accumulated and recorded, and after each accumulation and recording, operation 1103 is performed to determine whether the virtual environment and/or the virtual character satisfies the preset condition. For example, each time energy is accumulated, whether the accumulated energy reaches an energy threshold is determined.

Operation 1103: Determine whether the virtual environment and/or the virtual character satisfies the preset condition.

When the virtual environment and/or the virtual character satisfies the preset condition, operation 1104 is performed. When the virtual environment and/or the virtual character does not satisfy the preset condition, operation 1108 is performed.

Operation 1104: Repeatedly play a prompt animation.

The prompt animation is configured for prompting that a skill corresponding to a third activity is available. In other words, an enhanced appearance style in the embodiments of this application may alternatively be a presentation form of the prompt animation.

Operation 1105: Determine whether a long-press operation on a button control is triggered when the prompt animation is repeatedly played.

When the long-press operation is triggered on the button control of the terminal, the terminal determines whether the long-press operation is triggered when the prompt animation is repeatedly played, that is, determines whether the long-press operation is triggered after the button control is switched to the enhanced appearance style. When the prompt animation is repeatedly played, and the long-press operation is triggered on the button control, operation 1106 is performed.

Operation 1106: Control the virtual character to perform the third activity.

The terminal controls the virtual character to perform the third activity in response to the long-press operation.

Operation 1107: Skip accumulation and recording of the data item.

The terminal does not accumulate and record the data item.

Operation 1108: Control the virtual character to perform a first activity based on a click operation, or control the virtual character to perform a second activity based on the long-press operation.

When the button control has a basic appearance style, the virtual character may be controlled to perform the first activity based on the click operation, or the virtual character may be controlled to perform the second activity based on the long-press operation.

In conclusion, according to the virtual character control method provided in this application, one button control may be configured to control a virtual character to perform three activities. When the button control is displayed in a basic appearance style, the virtual character may be controlled to perform a first activity based on a first trigger operation on the button control, or the virtual character may be controlled to perform a second activity based on a second trigger operation on the button control. When the button control is displayed in an enhanced appearance style, the virtual character may still be controlled to perform the first activity based on the first trigger operation on the button control, or the virtual character is controlled to perform a third activity based on the second trigger operation on the button control. Triggering of three functions is implemented by using one button control and two trigger operations. Compared with that each function corresponds to one control, occupation of an area on a screen is reduced. In addition, two trigger operations are performed on one control, which is easy for a user to operate. In this way, disorder during mixing use of a plurality of operations does not occur. In addition, in the method, a user is also notified of a function change on a control by using an appearance style change of the button control, so that the user can accurately learn a time point of the function change, thereby better grasping a function trigger occasion.

Apparatus embodiments of this application are described below. For details that are not described in detail in the apparatus embodiments, reference may be made to the corresponding records in the foregoing method embodiments. Details are not described herein again.

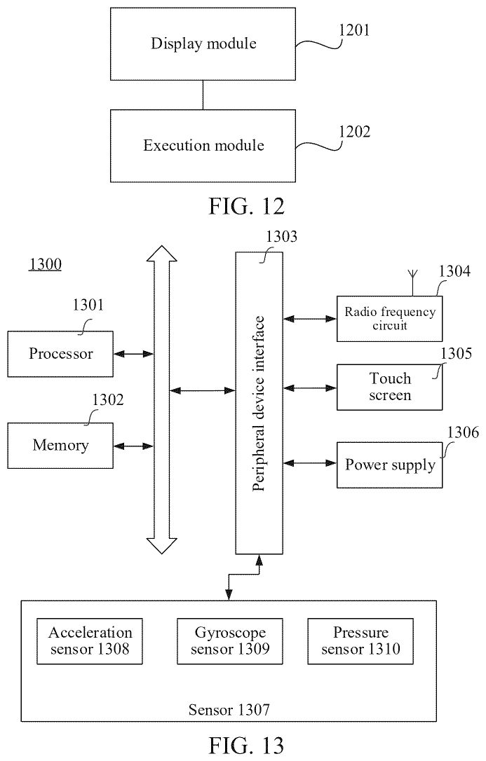

FIG. 12 is a schematic structural diagram of a virtual character control apparatus according to an exemplary embodiment of this application. The apparatus may be implemented as an entire terminal or a part of a terminal by using software, hardware, or a combination thereof. The apparatus includes:
a display module 1201, configured to display a virtual character located in a virtual environment and a button control having a basic appearance style; and
an execution module 1202, configured to control the virtual character to perform a first activity in response to a first trigger operation on the button control having the basic appearance style; or control the virtual character to perform a second activity in response to a second trigger operation on the button control having the basic appearance style, the display module 1201 being configured to switch, if the virtual environment
and/or the virtual character satisfies a preset condition, the button control having the basic appearance style from the basic appearance style to an enhanced appearance style; and
the execution module 1202 being configured to control the virtual character to perform a third activity in response to the second trigger operation on the button control having the enhanced appearance style.

In some embodiments, the preset condition includes at least two preset conditions, and the at least two preset conditions are associated with different enhanced appearance styles; and
the display module 1201 is configured to switch, if the virtual environment and/or the virtual character satisfies a first preset condition in the at least two preset conditions, the button control having the basic appearance style from the basic appearance style to a first enhanced appearance style associated with the first preset condition.

In some embodiments, the preset condition is correspondingly associated with at least two skills, and each skill is associated with a respective enhanced appearance style; and the display module 1201 is configured to:
display, if the virtual environment and/or the virtual character satisfies the preset condition, a selection control corresponding to the at least two skills around the button control having the basic appearance style; and
cancel the displaying of the selection control in response to a selection operation for a first skill in the at least two skills on the selection control, and switch the button control having the basic appearance style from the basic appearance style to a first enhanced appearance style associated with the first skill.

In some embodiments, the display module 1201 is configured to cancel the displaying of the selection control if a selection operation is not triggered on the selection control and display duration of the selection control reaches fourth duration, and switch the button control having the basic appearance style from the basic appearance style to the first enhanced appearance style associated with the first skill by default.

In some embodiments, the preset condition is correspondingly associated with at least two skills, and each skill is associated with a respective enhanced appearance style; and
the display module 1201 is configured to randomly switch, if the virtual environment and/or the virtual character satisfies the preset condition, the button control having the basic appearance style from the basic appearance style to a first enhanced appearance style associated with a first skill in the at least two skills.

In some embodiments, the preset condition includes at least one of the following:
the virtual character uses a specified virtual item;
a quantity of times that the virtual character performs the first activity or the second activity within first duration exceeds a quantity-of-times threshold;
a damage point outputted by the virtual character when performing the first activity or the second activity within second duration is greater than a damage threshold;
duration;
cool-down duration of a skill corresponding to the third activity reaches third the virtual character defeats another object in the virtual environment;
a health point of the virtual character is greater than a health threshold; and
the virtual environment supports the third activity to be performed.

In some embodiments, the display module 1201 is further configured to perform at least one of the following operations:
switching a first fill color of the button control having the basic appearance style to a second fill color;
switching a first pattern displayed on the button control having the basic appearance style to a second pattern;
switching first brightness displayed on the button control having the basic appearance style to second brightness, the second brightness being greater than the first brightness;
switching first transparency of the button control having the basic appearance style to second transparency; and
switching a first shape of the button control having the basic appearance style to a second shape.

In some embodiments, the display module 1201 is configured to display, after switching the button control having the basic appearance style from the basic appearance style to the enhanced appearance style, prompt content around the button control having the enhanced appearance style, the prompt content being configured for describing a skill corresponding to the third activity.

In some embodiments, the display module 1201 is configured to:
reserve, after switching the button control having the basic appearance style from the basic appearance style to the enhanced appearance style, a skill corresponding to the third activity in response to a third trigger operation on the button control having the enhanced appearance style, and switch the button control having the enhanced appearance style from the enhanced appearance style to another appearance style, the another appearance style being different from the enhanced appearance style; and
control the virtual character to perform the first activity in response to the first trigger operation on the button control having the another appearance style; or control the virtual character to perform the second activity in response to the second trigger operation on the button control having the another appearance style.

In some embodiments, the display module 1201 is configured to:
switch, in response to the third trigger operation triggered again on the button control having the another appearance style, the button control having the another appearance style from the another appearance style to the enhanced appearance style; and
control the virtual character to perform the third activity in response to the second trigger operation on the button control having the enhanced appearance style.

In some embodiments, the display module 1201 is configured to cancel, after switching the button control having the basic appearance style from the basic appearance style to the enhanced appearance style, a skill corresponding to the third activity in response to a fourth trigger operation on the button control having the enhanced appearance style and switch the button control having the enhanced appearance style from the enhanced appearance style to the basic appearance style.

In some embodiments, the display module 1201 is configured to switch, after controlling the virtual character to perform the third activity, the button control having the enhanced appearance style from the enhanced appearance style to the basic appearance style.

FIG. 13 is a structural block diagram of a computer device 1300 according to an exemplary embodiment of this application. The computer device 1300 may be a portable mobile terminal, such as a smart phone, a tablet computer, an MP3 player, or an MP4 player. The computer device 1300 may also be referred to as another name such as user equipment or a portable terminal.

Generally, the computer device 1300 includes a processor 1301 and a memory 1302.

The processor 1301 may include one or more processing cores, for example, a 4-core processor or an 8-core processor. The processor 1301 may be implemented in at least one hardware form of digital signal processing (DSP), a field-programmable gate array (FPGA), and a programmable logic array (PLA). The processor 1301 may alternatively include a main processor and a coprocessor. The main processor is a processor configured to process data in an awake state, and is also referred to as a central processing unit (CPU). The coprocessor is a low power consumption processor configured to process data in a standby state. In some embodiments, the processor 1301 may be integrated with a graphics processing unit (GPU). The GPU is configured to be responsible for rendering and drawing content that needs to be displayed on a screen. In some embodiments, the processor 1301 may further include an artificial intelligence (AI) processor. The AI processor is configured to process a computing operation related to machine learning.

The memory 1302 may include one or more computer-readable storage media. The computer-readable storage medium may be tangible and non-transient. The memory 1302 may further include a high-speed random access memory and a non-volatile memory, for example, one or more disk storage devices or flash memory storage devices. In some embodiments, the non-transient computer-readable storage medium in the memory 1302 is configured to store at least one instruction. The at least one instruction is executed by the processor 1301 to perform the virtual character control method provided in this application.

In some exemplary embodiments, the computer device 1300 further includes a peripheral device interface 1303 and at least one peripheral device. Specifically, the peripheral device includes at least one of a radio frequency circuit 1304, a touch screen 1305, and a power supply 1306.

In some embodiments, the computer device 1300 further includes one or more sensors 1307. The one or more sensors 1307 include, but are not limited to: an acceleration sensor 1308, a gyroscope sensor 1309, and a pressure sensor 1310.

A person skilled in the art may understand that the structure shown in FIG. 13 does not constitute any limitation on the computer device 1300, and the computer device may include more components or fewer components than those shown in the figure, or some components may be combined, or a different component deployment may be used.

This application further provides a computer device. The computer device includes a processor and a memory. The memory has at least one program stored therein. The at least one program is loaded and executed by the processor to implement the virtual character control method provided in the foregoing method embodiments.

This application further provides a computer-readable storage medium. The medium has at least one program stored therein. The at least one program is loaded and executed by the processor to implement the virtual character control method provided in the foregoing method embodiments.

This application further provides a computer program product. When the computer program product runs on a computer, the computer is caused to perform the virtual character control method provided in the foregoing method embodiments.

The “plurality of” mentioned in this specification means two or more. The “and/or” describes an association relationship between associated objects and represents that three relationships may exist. For example, A and/or B may represent the following three cases: Only A exists, both A and B exist, and only B exists. The character “/” generally indicates an “or” relationship between the associated objects.

A person of ordinary skill in the art may understand that all or part of the operations of implementing the foregoing embodiments may be implemented by hardware, or may be implemented by a program instructing related hardware. The program may be stored in a computer-readable storage medium. The storage medium mentioned may be a read-only memory, a magnetic disk, or an optical disc.

The foregoing descriptions are merely exemplary embodiments of this application, but are not intended to limit this application. Any modification, equivalent replacement, or improvement made without departing from the spirit and principle of this application is to fall within the protection scope of this application.

What is claimed is:

1. A virtual character control method performed by a computer device, the method comprising:
displaying a virtual character located in a virtual environment and a button control having a basic appearance style;
controlling the virtual character to perform a first activity in response to a first trigger operation on the button control having the basic appearance style;
when the virtual environment and the virtual character satisfies a preset condition, switching the button control having the basic appearance style from the basic appearance style to an enhanced appearance style; and
controlling the virtual character to perform a second activity in response to a second trigger operation on the button control having the enhanced appearance style.

2. The method according to claim 1, wherein the preset condition comprises at least two preset conditions, and the at least two preset conditions are associated with different enhanced appearance styles; and
the switching the button control having the basic appearance style from the basic appearance style to the enhanced appearance style comprises:
switching the button control having the basic appearance style from the basic appearance style to a first enhanced appearance style associated with one of the at least two preset conditions.

3. The method according to claim 1, wherein the preset condition is correspondingly associated with at least two skills, and each skill is associated with a respective enhanced appearance style; and
the switching the button control having the basic appearance style from the basic appearance style to the enhanced appearance style comprises:
displaying, when the virtual environment and/or the virtual character satisfies the preset condition, a selection control corresponding to the at least two skills around the button control having the basic appearance style; and
canceling the displaying of the selection control in response to a selection operation for a first skill in the at least two skills on the selection control, and switching the button control having the basic appearance style from the basic appearance style to a first enhanced appearance style associated with the first skill.

4. The method according to claim 1, wherein the preset condition is correspondingly associated with at least two skills, and each skill is associated with a respective enhanced appearance style; and
the switching the button control having the basic appearance style from the basic appearance style to the enhanced appearance style comprises:
randomly switching the button control having the basic appearance style from the basic appearance style to a first enhanced appearance style associated with a first skill in the at least two skills.

5. The method according to claim 1, wherein the preset condition comprises at least one of the following:
the virtual character uses a specified virtual item;
a quantity of times that the virtual character performs the first activity or the second activity within first duration exceeds a quantity-of-times threshold;
a damage point outputted by the virtual character when performing the first activity or the second activity within second duration is greater than a damage threshold;
cool-down duration of a skill corresponding to the second activity reaches third duration;
the virtual character defeats another object in the virtual environment;
a health point of the virtual character is greater than a health threshold; and
the virtual environment supports the second activity to be performed.

6. The method according to claim 1, wherein the switching the button control having the basic appearance style from the basic appearance style to the enhanced appearance style comprises at least one of the following operations:
switching a first fill color of the button control having the basic appearance style to a second fill color;
switching a first pattern displayed on the button control having the basic appearance style to a second pattern;
switching first brightness displayed on the button control having the basic appearance style to second brightness, the second brightness being greater than the first brightness;
switching first transparency of the button control having the basic appearance style to second transparency; and
switching a first shape of the button control having the basic appearance style to a second shape.

7. The method according to claim 1, wherein after the switching the button control having the basic appearance style from the basic appearance style to the enhanced appearance style, the method further comprises:
displaying prompt content around the button control having the enhanced appearance style, the prompt content being configured for describing a skill corresponding to the second activity.

8. The method according to claim 1, wherein after the switching the button control having the basic appearance style from the basic appearance style to the enhanced appearance style, the method further comprises:
reserving a skill corresponding to the second activity in response to a third trigger operation on the button control having the enhanced appearance style, and switching the button control having the enhanced appearance style from the enhanced appearance style to another appearance style, the another appearance style being different from the enhanced appearance style; and
controlling the virtual character to perform the first activity in response to the first trigger operation on the button control having the another appearance style, or controlling the virtual character to perform the second activity in response to the second trigger operation on the button control having the another appearance style.

9. The method according to claim 1, wherein after the switching the button control having the basic appearance style from the basic appearance style to the enhanced appearance style, the method further comprises:
canceling a skill corresponding to the second activity in response to a fourth trigger operation on the button control having the enhanced appearance style, and switching the button control having the enhanced appearance style from the enhanced appearance style to the basic appearance style.

10. The method according to claim 1, wherein after the controlling the virtual character to perform the second activity, the method further comprises:
switching the button control having the enhanced appearance style from the enhanced appearance style to the basic appearance style.

11. A computer device, comprising a processor and a memory, the memory having at least one program stored therein, the at least one program being loaded and executed by the processor and causing the computer device to implement a virtual character control method including:
displaying a virtual character located in a virtual environment and a button control having a basic appearance style;
controlling the virtual character to perform a first activity in response to a first trigger operation on the button control having the basic appearance style;
when the virtual environment and the virtual character satisfies a preset condition, switching the button control having the basic appearance style from the basic appearance style to an enhanced appearance style; and
controlling the virtual character to perform a second activity in response to a second trigger operation on the button control having the enhanced appearance style.

12. The computer device according to claim 11, wherein the preset condition comprises at least two preset conditions, and the at least two preset conditions are associated with different enhanced appearance styles; and
the switching the button control having the basic appearance style from the basic appearance style to the enhanced appearance style comprises:
switching the button control having the basic appearance style from the basic appearance style to a first enhanced appearance style associated with one of the at least two preset conditions.

13. The computer device according to claim 11, wherein the preset condition is correspondingly associated with at least two skills, and each skill is associated with a respective enhanced appearance style; and
the switching the button control having the basic appearance style from the basic appearance style to the enhanced appearance style comprises:
displaying, when the virtual environment and/or the virtual character satisfies the preset condition, a selection control corresponding to the at least two skills around the button control having the basic appearance style; and
canceling the displaying of the selection control in response to a selection operation for a first skill in the at least two skills on the selection control, and switching the button control having the basic appearance style from the basic appearance style to a first enhanced appearance style associated with the first skill.

14. The computer device according to claim 11, wherein the preset condition is correspondingly associated with at least two skills, and each skill is associated with a respective enhanced appearance style; and
the switching the button control having the basic appearance style from the basic appearance style to the enhanced appearance style comprises:
randomly switching the button control having the basic appearance style from the basic appearance style to a first enhanced appearance style associated with a first skill in the at least two skills.

15. The computer device according to claim 11, wherein the preset condition comprises at least one of the following:
the virtual character uses a specified virtual item;
a quantity of times that the virtual character performs the first activity or the second activity within first duration exceeds a quantity-of-times threshold;
a damage point outputted by the virtual character when performing the first activity or the second activity within second duration is greater than a damage threshold;
cool-down duration of a skill corresponding to the second activity reaches third duration;
the virtual character defeats another object in the virtual environment;
a health point of the virtual character is greater than a health threshold; and
the virtual environment supports the second activity to be performed.

16. The computer device according to claim 11, wherein after the switching the button control having the basic appearance style from the basic appearance style to the enhanced appearance style, the method further comprises:
displaying prompt content around the button control having the enhanced appearance style, the prompt content being configured for describing a skill corresponding to the second activity.

17. The computer device according to claim 11, wherein after the switching the button control having the basic appearance style from the basic appearance style to the enhanced appearance style, the method further comprises:
reserving a skill corresponding to the second activity in response to a third trigger operation on the button control having the enhanced appearance style, and switching the button control having the enhanced appearance style from the enhanced appearance style to another appearance style, the another appearance style being different from the enhanced appearance style; and
controlling the virtual character to perform the first activity in response to the first trigger operation on the button control having the another appearance style, or controlling the virtual character to perform the second activity in response to the second trigger operation on the button control having the another appearance style.

18. The computer device according to claim 11, wherein after the switching the button control having the basic appearance style from the basic appearance style to the enhanced appearance style, the method further comprises:
canceling a skill corresponding to the second activity in response to a fourth trigger operation on the button control having the enhanced appearance style, and switching the button control having the enhanced appearance style from the enhanced appearance style to the basic appearance style.

19. The computer device according to claim 11, wherein after the controlling the virtual character to perform the second activity, the method further comprises:
switching the button control having the enhanced appearance style from the enhanced appearance style to the basic appearance style.

20. A non-transitory computer-readable storage medium, having at least one program stored therein, the at least one program being loaded and executed by a processor of a computer device and causing the computer device to implement a virtual character control method including:
displaying a virtual character located in a virtual environment and a button control having a basic appearance style;
controlling the virtual character to perform a first activity in response to a first trigger operation on the button control having the basic appearance style;
when the virtual environment and the virtual character satisfies a preset condition, switching the button control having the basic appearance style from the basic appearance style to an enhanced appearance style; and
controlling the virtual character to perform a second activity in response to a second trigger operation on the button control having the enhanced appearance style.
